(19) United States
(12) Patent Application Publication
(10) Pub. No.: US 2024/0156680 A1
(43) Pub. Date: May 16, 2024

(54) PORTABLE EYEWASH EYEPIECE

(71) Applicants: George Raupp, New Hope, PA (US); Allen Sassman, Lambertville, NJ (US)

(72) Inventors: George Raupp, New Hope, PA (US); Allen Sassman, Lambertville, NJ (US)

(21) Appl. No.: 18/069,698

(22) Filed: Dec. 21, 2022

Related U.S. Application Data
(60) Provisional application No. 63/383,525, filed on Nov. 14, 2022.

(51) Int. Cl. A61H 35/02

(52) U.S. Cl. CPC A61H 35/02

(57) ABSTRACT

An eyewash eyepiece has an upper section with an eyepiece member fabricated of pliable, form fitting material and a lower section having a bottom floor with a plurality of holes. The eyepiece member is configured to be placed on and surround the outer boundaries of the user's eye. Once in place over the user's eye, the eyepiece member creates a watertight seal against the outer boundaries. The eyepiece then accepts water or other eye cleaning liquid from a water bottle or similar container which is threadably secured to the eyepiece. The liquid flows through the eyepiece, past the eyepiece member, and into the eye to wash out any foreign matter and cleanse the eye.

### RELATED APPLICATION

This application claims the benefit of provisional application No. 63/383,525, filed on Nov. 14, 2022.

### FIELD OF THE INVENTION

The present invention generally relates to eyewash devices which assist in providing liquid to cleanse and treat the eye of a user.

### BACKGROUND OF THE INVENTION

There are a number of eyewash devices and eyewash cleaning stations which are designed to rinse out the eyes of an individual with water or other eye clearing solution, in order to flush out and remove dirt or foreign material from the eye. However, such eyewash devices require the use of specific eye cleaning solutions or sources of water which may not be readily available when the user needs to clean his or her eye. Eyewash cleaning stations are also not always available or accessible and they are certainly not portable in most circumstances. This is the case, for instance, when eyes need to be cleaned during an outdoor activity, when one is in a vehicle on the road, or in similar situations in which the availability of eyewashes devices, eyewash stations or even eyewash solutions or water are non-existent.

### SUMMARY OF THE INVENTION

It is thus the object of the present invention to provide an eyewash eyepiece which addresses and overcomes the disadvantages and limitations of prior eyewash devices and eyewash stations.

These and other objects of the present invention are accomplished by an eyewash eyepiece which is configured to be placed on and surround the outer boundaries of the user's eye. The eyepiece is designed to create a watertight seal against these outer boundaries and then accept water or other eye cleaning liquid from a water bottle or similar container which is threadably secured to the eyepiece. The liquid flows through the eyepiece into the eye to wash out any foreign matter and in order to cleanse the eye.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a top perspective view of the present invention.

FIG. 2 is a bottom perspective view of the present invention.

FIG. 3 is a front view of the present invention.

FIG. 4 is a rear view of the present invention.

FIG. 5 is an elevation view of the present invention.

FIG. 6 is a section view of the present invention taken from FIG. 3.

FIG. 7 is a section view of the present invention taken from FIG. 5.

FIG. 8 is a top view of the present invention.

FIG. 9 is a bottom view of the present invention.

FIG. 10 shows the relationship between the present invention and a water bottle which is to be used in conjunction with the invention.

FIG. 11 illustrates the use of the present invention in order to cleanse the eye of a user.

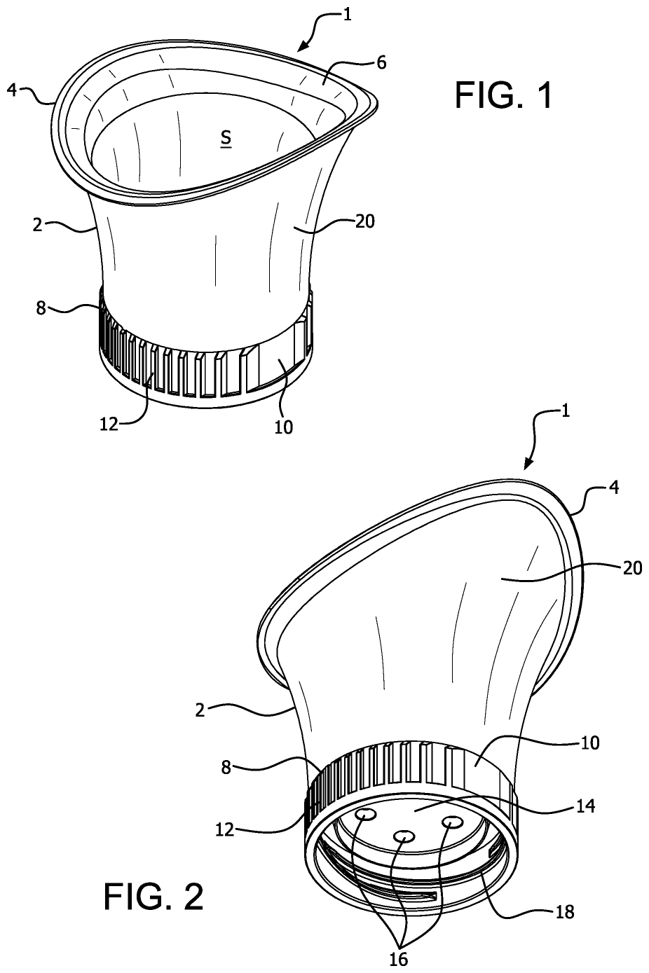

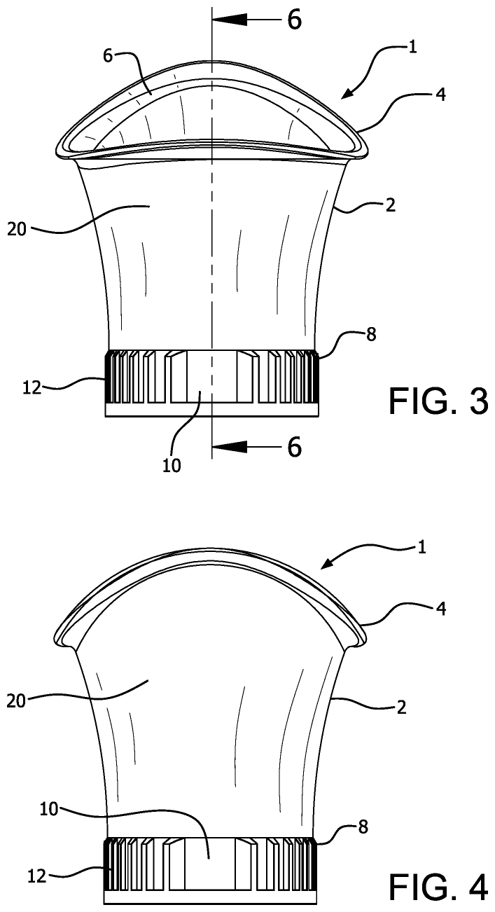

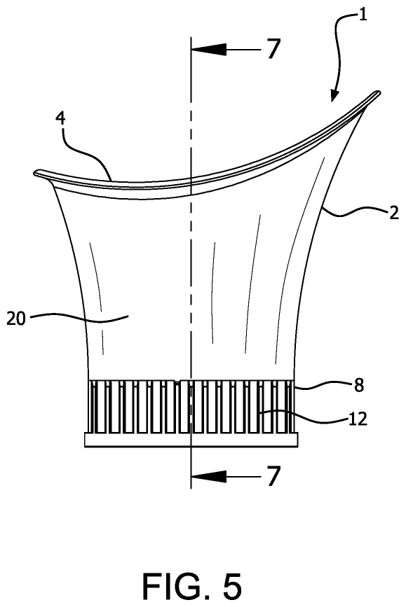

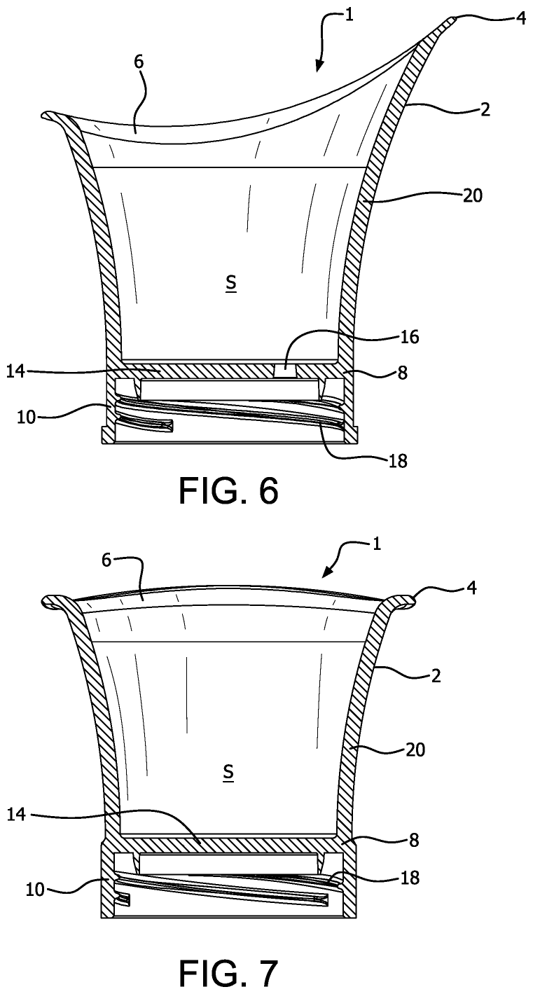

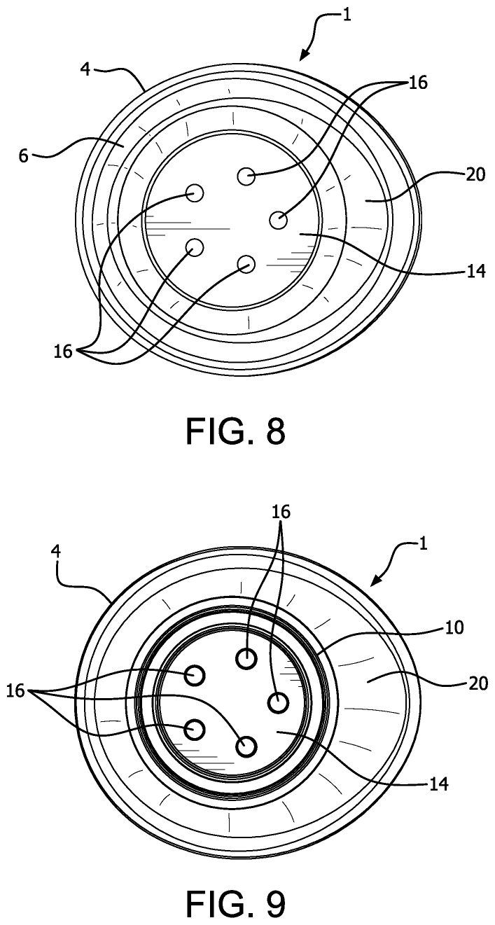

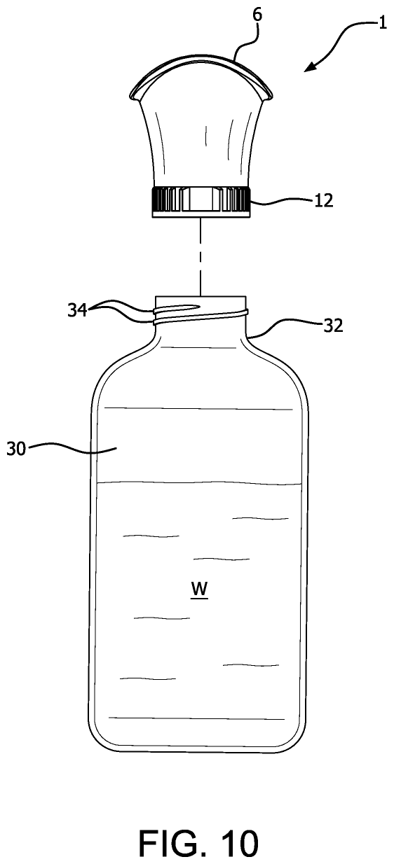

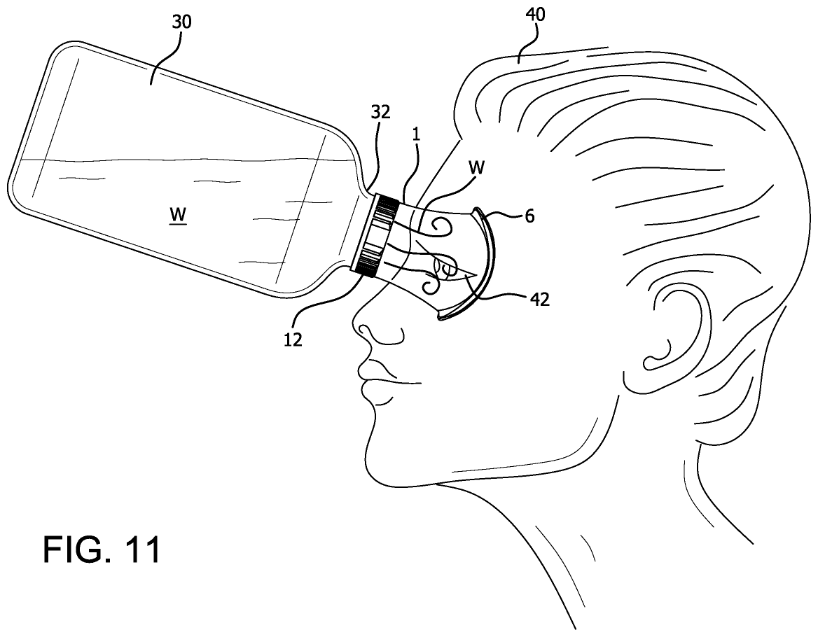

### DETAILED DESCRIPTION OF THE INVENTION

Eyewash eyepiece 1 of the present invention comprises upper section 2 having eyepiece member 4 fabricated from resilient plastic or equivalent flexible form-fitting material. Eyepiece member 4 has top curved outer rim 6 configured to comfortably surround the outer boundaries of the user's eye and form a watertight seal at these outer boundaries. Lower section 8 of eyewash eyepiece 1 has circular sidewall 10 with externally extending grip section 12 and internal screw threading 18. Sidewall 10 circumscribes bottom floor 14 of lower section 8. Floor 14 has a plurality of through holes 16. Smooth, upwardly curved sides 20 extend from sidewall 10 to wider eyepiece member 4. Open space 5 is formed between bottom floor 14 and eyepiece member 4.

In use, screw threads 34 on neck 32 of water bottle 30 are threadably engaged with screw threading 18 of eyewash eyepiece 1. Eyepiece member 4 is then positioned over eye 42 of user 40, and gently pushed down in order to form a watertight seal between outer rim 6 of the eyepiece member and the outer boundaries of the eye. Bottle 30 is raised, or squeezed in the case of a plastic bottle, to allow water W or other cleansing liquid to slowly flow through holes 16 in lower section 8, and then into eye 42 of user 40, in order to flush out any foreign matter and generally cleanse the eye.

While the use of water from water bottle 30 is disclosed herein, it is contemplated that any bottled eye cleaning solution having a threaded neck can be utilized with eyewash eyepiece 1 as well. In this manner, the eyewash eyepiece of the present invention can not only be used with water or other eye washing liquids in order to cleanse the eye, it also can be utilized in combination with solutions to address dry eye conditions.

The eyewash eyepiece 1 is portable and, with only a threaded bottle of water or other eye cleansing liquid, is quite easy to use. Thus, the eyes of an individual which need to be treated when he or she is in a remote location or when commonly used eyewashing devices are not available, can be effectively treated by the eyewash eyepiece of the present invention.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. An eyewash eyepiece for surrounding the outer boundaries of a user's eye, said eyepiece comprising:
an upper section having an eyepiece member fabricated of flexibly form-fitting material for placement over and for providing a watertight seal around the outer boundaries of a user's eye;
a lower section extending from the upper section, said lower section having a circular sidewall with internal screw threading, said sidewall circumscribing a bottom floor having a plurality of holes; wherein the screw threading of the sidewall is configured to threadably engage with screw threads on the neck of a liquid-containing bottle to allow said liquid to flow from the bottle, into the lower section, through the plurality of holes, into the upper section, and into the user's eye in order to cleanse the eye.

2. The eyewash eyepiece as in claim 1 wherein the eyepiece member has a top curved outer rim configured to be positioned on the outer boundaries of the user's eye for providing the watertight seal.

3. The eyewash eyepiece as in claim 2 wherein curved sides extend from the bottom floor to the eyepiece member, forming an open space therebetween.

4. The eyewash eyepiece as in claim 1 further comprising a grip section on the sidewall.

5. The method of cleansing a user's eye, said method comprising the steps of:
providing an eyewash eyepiece having an upper section fabricated of flexibly form-fitting material, a lower section extending from the upper section, said lower section having a circular sidewall with internally extending screw threading, the sidewall circumscribing a bottom floor having a plurality of holes;
providing a bottle containing an eye cleansing liquid and having a bottle neck with screw threads;
threadably engaging the screw threading of the lower section of the eyewash eyepiece with the screw threads of the liquid containing bottle;
positioning the upper section of the eyewash eyepiece so that it surrounds the outer boundaries of a user's eye such that a watertight seal is formed between the upper section and the outer boundaries; and
allowing the eye cleansing liquid to flow from the bottle, through the lower section, through the plurality of holes, through the upper section and into the user's eye to cleanse the eye.
